(19) United States
(12) Patent Application Publication
(10) Pub. No.: US 2001/0011227 A1
(43) Pub. Date: Aug. 2, 2001

(54) METHOD AND APPARATUS FOR COLLECTING INFORMATION ASSOCIATED WITH MOVEMENT BETWEEN LOCATIONS

(76) Inventors: LAWRENCE E. ASHERY, VALLEY FORGE, PA (US); KENNETH ALAN GOLDMAN, NORWALK, CT (US); ELAINE RIVETTE PALMER, GOLDEN BRIDGE, NY (US); PANKAJ ROHATGI, YORKTOWN HEIGHTS, NY (US); SEAN WILLIAM SMITH, CORNWALL, NY (US)

Correspondence Address: LAWRENCE E. ASHERY, RATNER & PRESTIA, SUITE 301, ONE WESTLAKES(BERWYN) PO BOX 980, VALLEY FORGE, PA, 194820980

(21) Appl. No.: 09/054,924

(22) Filed: Apr. 3, 1998

(51) Int. Cl. G06F 17/60

(52) U.S. Cl. 705/14; 705/10; 705/22

(57) ABSTRACT

A system collects information associated with movement between locations. The system includes individual cards. Each individual card has a storage area and an interactor for receiving promotional unit data. A plurality of promotional units are also included. Each promotional unit transmits respective promotional unit data to any card with which it interacts. The promotional unit data within each card may then be downloaded to determine with which promotional units interaction has occurred.

### FIELD OF THE INVENTION

The present invention relates to information associated with movement between locations and more particularly the collection of that information. Specifically, cards are disclosed which interact with promotional units to collect information associated with card movement between locations.

### BACKGROUND OF THE INVENTION

Individuals exhibit various types of behavior. In some situations, it may be useful to collect information associated with that behavior.

In a retail scenario, for example, shoppers choose to purchase (or not to purchase) various products. As the shopper selects various items for purchase, the shopper is exhibiting what is referred to as shopper behavior.

In many current retail scenarios, shoppers are provided with a physical token to identify them, to encourage various shopping activities, and to provide a mechanism for an administrating party to collect information regarding shopper behavior.

For example, many grocery stores now provide their customers with “frequent shopper” cards. Each card allows a customer to be identified with a unique identification code which may be stored on the card in the form of a bar-code or a magnetic stripe, for example. The store then provides various discounts when a customer presents his/her card at the check-out line. Customer-specific data associated with the card can be provided via a network from the check-out line to a central computer.

As another example, many shopping complexes provide a parking validation service. Customers receive a ticket when they park their car. Customers who have this ticket validated at a participating store in the complex may have their parking fee reduced or eliminated.

In each of these examples, marketing information may be obtained. For example, the administrating party can compare a customer's current purchases with a customer's previous purchases. The administrating party can then determine whether a product discount (or advertisement of the product discount) resulted in the product purchase. Furthermore, when such a scheme is used in a variety of stores, this technique provides an indication of relative store popularity.

These schemes, however, suffer from several limitations.

Shopper promotions may be limited as well as difficult to use. For example, finding “discount” tags on the shelves of modem grocery stores may be an overly burdensome task.

Furthermore, opportunities for demographic data collection are limited to actions of shoppers which are truly affirmative. Thus, for example, it is possible to identify at which store a customer redeemed his/her parking coupon. Furthermore, it is possible to identify which discounted products were actually purchased by the individual. Other valuable data may not be obtainable by this technique. For example, using this technique, it is difficult to identify which discounts the shopper considered but discarded. It is also difficult to identify which promotions the shopper walked by without noticing. The actual route of the customer through the store is also difficult to obtain.

### SUMMARY OF THE INVENTION

A system collects information associated with movement between locations. The system includes individual cards. Each individual card has a storage area and a interactor for receiving promotional unit data. A plurality of promotional units are also included. Each promotional unit transmits respective promotional unit data to any card with which it interacts. The data within each card may then be downloaded to determine with which promotional units interaction has occurred.

### BRIEF DESCRIPTION OF THE DRAWINGS

FIG. 1 is a block diagram of a first exemplary embodiment of the present invention. An optional aspect of this first exemplary embodiment is also shown.

FIG. 2 is a block diagram of a second exemplary embodiment of the present invention. An optional aspect of this second exemplary embodiment is also shown.

FIG. 3 is a flowchart diagram which is useful for explaining operation of an exemplary embodiment of the present invention.

FIG. 4 is a further flowchart diagram which is also useful for explaining operation of an exemplary embodiment of the present invention.

FIG. 5 is a block diagram of a further exemplary embodiment of the present invention. This exemplary embodiment may also include several optional aspects.

### DETAILED DESCRIPTION OF THE INVENTION

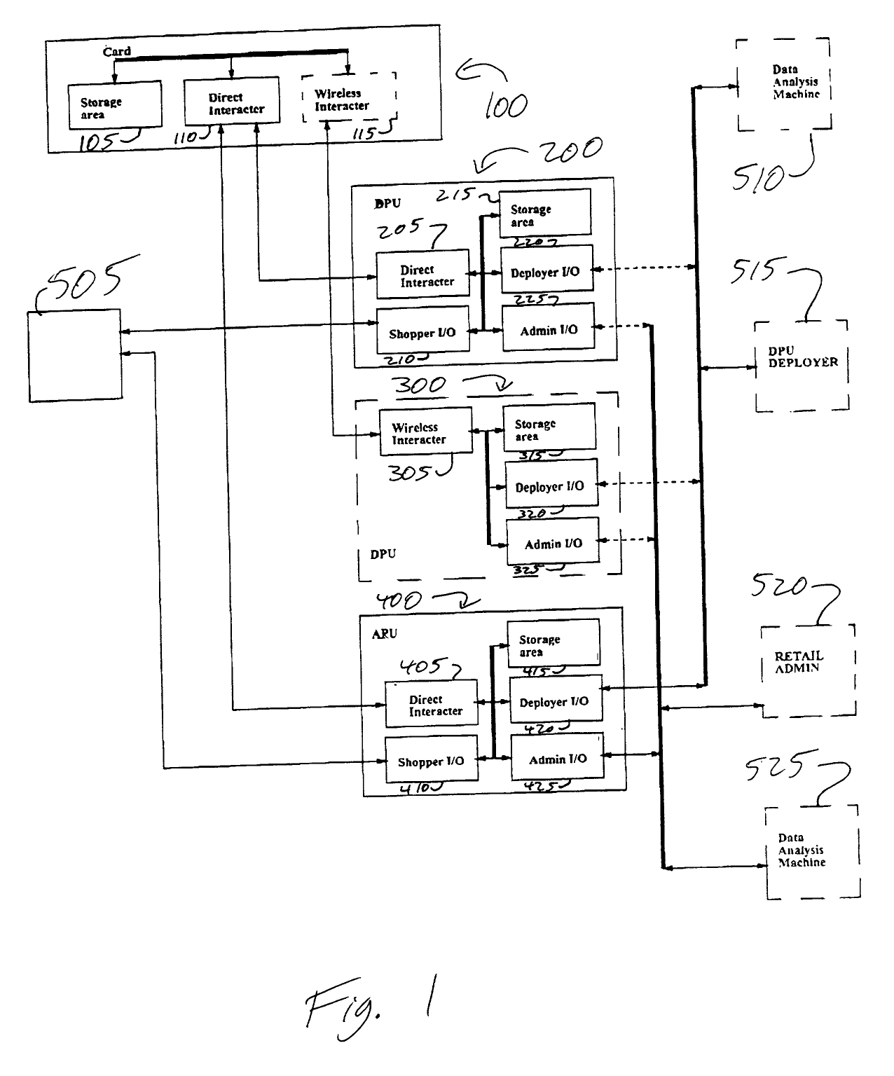

A first exemplary embodiment of the present invention is illustrated in FIG. 1. Optional aspects of this embodiments are also shown in FIG. 1. As shown, FIG. 1 includes individual card 100, promotional unit 200, and administrative unit 400. Typically, multiple individual cards, promotional units and administrative units may be used. Each promotional unit may be situated, for example, in a different location within a retail complex. An individual 505 carriers his/her individual card 100 as he/she goes from place to place within the retail complex. Individual 505 may be a person (such as a shopper) who is shopping in the retail complex. Each time individual card 100 interacts with any of the promotional units 200 within the retail complex, the promotional unit 200 transmits promotional unit data to individual card 100. Promotional unit data may be, for example, a code uniquely identifying the promotional unit 200 which is interacting with individual card 100. Alternatively, promotional unit data may serve as some other form of identification, such as identifying a product, a group of products, a particular location in a store, a generalized location in a store, etc. As individual 505 continues to move through the retail complex and causes his/her individual card 100 to interact with various promotional units 200, individual card 100 stores the promotional unit data it has received. This may include, for example, building a list corresponding to all the promotional units with which it has interacted. At a later time, for example when individual 505 exits the retail complex, the promotional unit data which has been stored within individual card 100 may be retrieved. In this way, it is possible to determine where, for example, the individual went while he/she was within the retail complex.

Individual card 100 includes storage area 105 and one (or more) direct interactor 110. Direct interactor 110 may possess active computational ability. Thus, direct interactor 110 can conduct (potentially) complicated exchanges over direct electrical connections. Individual card 100 may be, for example, a standard integrated circuit (IC) chip card. This is also referred to as a “smart card.” Illustrative smart cards are described, for example, in ISO/IEC 10536-1: 1992 Identification Cards-Contactless Integrated Circuit(s) Cards—Part 1: Physical Characteristics, ISO/IEC 10536-2: 1995 Identification Cards—Contactless Integrated Circuit(s) Cards—Part 2: Dimensions and Location of Coupling Areas, and ISO/IEC 10536-3: 1996 Identification Cards—Contactless Integrated Circuit(s) Cards—Part 3: Electronic Signals and Reset Procedures. Furthermore, an exemplary shopper card may be an IBM MFC 4.0 card manufactured by IBM Corporation. Storage area 105 may be implemented by internal EEPROM.

Promotional unit 200 may be a stand alone external device which interacts with individual card 100. Alternatively, several promotional units 200 may be networked together.

Promotional unit 200 may include direct interactor 205. Direct interactor 205 enables promotional unit 200 to communicate with direct interactor 110 which is included in individual card 100.

Shopper I/O 210 may be a sound or visual device for communicating within individual 505. Thus, for example, shopper I/O 210 may prompt individual 505 to place his/her individual card 100 within proximity to promotional unit 200 so that communication between individual card 100 and promotional unit 200 may occur. Shopper I/O 210 may also suggest that a shopper go to certain physical locations, or may be used for product or incentive advertising.

Storage area 215 is also included in promotional unit 200. Storage area 215 may be used for a variety of storage purposes. Storage area 215 may be used for storing the program code which enables operation of promotional unit 200. Storage area 215 may optionally contain state variables which are modified based on certain interactions (or numbers of interactions) with individual cards 100. Thus, for example, a state variable assuming a certain state may trigger monetary incentives (i.e., discounts, bonuses, etc.) for individual 505. Storage area 215 may optionally contain logs of interactions with individual cards 100 which have occurred.

Deployer I/O 220 is included. Deployer I/O 220 enables programming of promotional unit 200. Thus, for example, promotional unit 200 can be programmed to interact with individual cards 100 in a variety of different ways. For example, shopper I/O 210 may provide different prompts to individual 505. Promotional unit 200 may provide different bonuses to different individual cards 100 based on which individual card 100 (or the number of individual cards 100) that have interacted with promotional unit 200.

As previously stated, storage area 215 may include state variables which are modified based upon the interactions with individual cards 100. Furthermore, promotional unit 200 may provide different bonuses to individual card 100 based on factors such as the time of interaction, the day of interaction, the date of interaction, etc. As can be seen, there are many ways for promotional unit 200 to interact with individual card 100. Deployer I/O 220 provides a means to program promotional unit 200 in the manner in which it should interact with individual cards 100.

Optionally, if promotional unit 200 is recording interactions with individual cards 100, then deployer I/O 220 permits a record of these interactions to be retrieved from promotional unit 200. Retrieval may be accomplished, for example, by temporarily attaching a stand-alone device to deployer I/O 220 or by having deployer I/O 220 permanently wired to an appropriate node.

Admin I/O 225 is also included. Admin I/O 225 is similar in operation to deployer I/O 220. One difference between these two devices is who is using them. For example, promotional unit 200 may have been placed in the retail complex by an outside company such as a marketing firm or a product manufacturer. These parties are referred to as “deployers.” The data which is obtained by promotional units 200 and individual cards 100 may be useful to the entity actually selling the product to the consumer. This entity is referred to as the “administrator.” Thus, the deployer and the administrator may each want to be able to program promotional unit 200. The deployer and the administrator may also each want to obtain information from promotional unit 200. Thus, a separate I/O channel is optionally provided so that each entity may perform the programming and obtain the information which each entity respectively desires. These I/O channels may be physically separate or logically separate (and thus physically shared).

Promotional unit 200 may also include, for example, a separate display for advertising and logos.

Administrative unit 400 is also included. Administrative unit 400 is similar to promotional unit 200. Multiple administrative units 400 may be networked together. Each administrative unit 400 interacts with individual card 100 in several roles, including (but not limited to) issuing each individual card to respective individuals (i.e., printing or programming cards), dispensing cards to individuals as they enter a store, receiving information from individual cards upon each individual exiting from a store (exit units), and collecting cards as individuals exit (from a store).

Data analysis machine 525 is also included. Data analysis machine 525 may perform one (or more) of several functions, including the collection, correlation, and analysis of data from promotional unit 200 and administrative unit 400. Thus, data analysis machine 525 may perform what is referred to as “data mining”. As defined by Gardner, C. IBM Data Mining Technology, “Data mining is the process of extracting valid, previously unknown, and ultimately comprehensible information from large databases and using it to make crucial business decisions.” Data analysis machine 525 may be, for example, a standard computer workstation, running special purpose data mining software. Data analysis machine 525 may correlate the information obtained by admin I/O 225 and/or admin I/O 425 with other information obtained, for example, directly from individual 505 or through point-of-sale devices. This enables, for example, a comparison of a) the items associated with promotional units 200 which, in turn, interacted with individual card 100 with b) the actual items acquired (or purchased) by individual 505.

Promotional unit 200 and administrative unit 400 may each be built around a smart card reader. Two possible considerations for promotional unit 200 and administrative unit 400 are a) whether these units are wireless or direct interface, and b) whether these units are stand alone or coupled together. Exemplary smart card readers include IBM 5948B02 (direct, coupled), IBM 5948B03 (direct, stand alone), GEMPlus GCR500 (direct, stand alone), GEMPlus GCR400-FD (direct, coupled), GEMPlus GC1680 (wireless, coupled). Implementation of smart card readers are also described in Organisation-International Electrotechnical Commission (ISO/IEC) 14443 Contactless Integrated Circuit Card Standard.

Depending upon a desired complexity of promotional unit 200 and administrative unit 400, either a stand alone smart card reader as described above may be used or a smart card reader coupled, for example, to an IBM PC may be used. Current “point-of-sale” devices currently available may be suitable with modifications which would be understood to one of ordinary skill in the art.

Data analysis machine 525 may be, for example, an IBM OS-390 or AS/400 machine running software such as IBM Intelligent Miner.

One of the purposes of the present invention is to enable collection and analysis of data on individual behavior. Machine 525 enables this analysis. Thus, machine 525 enables the administrator, for example, to process the records that they download from individual cards 100. This information may be correlated with the data gathered, for example, from a “point-of-sale” device or from a shopper directly. Various options may permit the creation of data records that may be owned (or purchased) by deployers. Thus, the promotional units may store records that may be downloaded, occasionally, using, for example, FLASH memory cards. In any event, data analysis machine 510 may optionally be included. Data analysis machine 510 enables the deployer to provide data mining as appropriate.

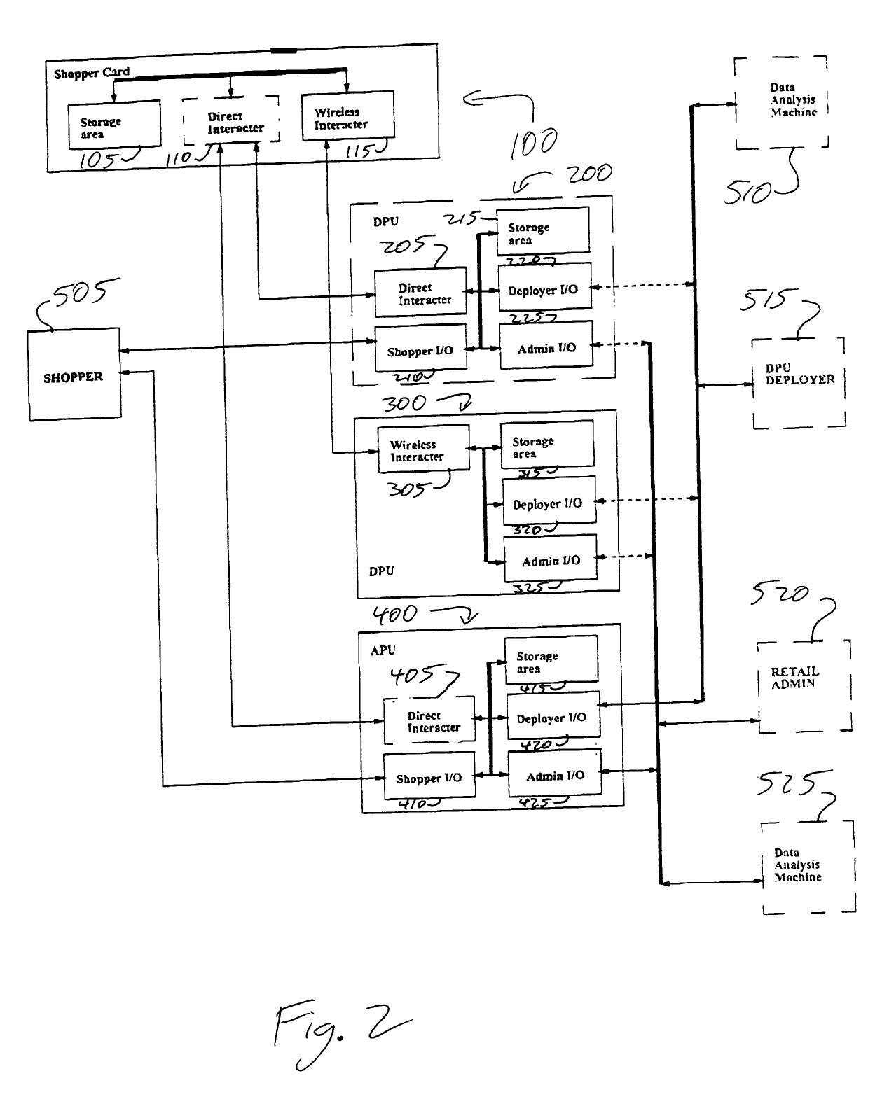

A further exemplary embodiment of the present invention is shown in FIG. 2. FIG. 2 differs from FIG. 1 in that FIG. 2 shows promotional unit 300 as a preferred aspect of this embodiment. Promotional unit 300 includes wireless interactor 305. Wireless interactor 305 is able to communicate with storage area 315, deployer I/O 320, and admin I/O 325. Other than wireless interactor 305, the other components shown in FIG. 2 associated with promotional unit 300 are similar to those found within promotional unit 200. Because promotional unit 300 includes wireless interactor 305, individual card 100 preferably includes wireless interactor 115. Thus, wireless interactor 305 and wireless interactor 115 may communicate with each other when wireless interactor 115 and wireless interactor 305 are within sufficient proximity for communication to occur.

Administrative unit 400 may optionally include a wireless interactor. This wireless interactor may interact with individual card 100 when individual card 100 and administrative unit 400 are within sufficient proximity for the two to communicate.

As shown in FIG. 1, although the use of promotional unit 200 is preferred, the use of promotional unit 300 may optionally also be included. Also, as shown in FIG. 2, although the use of promotional unit 300 is preferred, the use of promotional unit 200 is also optionally included.

In an exemplary embodiment of the present invention, a customer enters a retail complex (i.e., store) with his individual card 100 (e.g., the customer's “smart card”). The card was previously dispensed to the customer and was encoded so that it uniquely identifies that customer. The customer moves around the store. As the customer moves, his individual card 100 interacts with various promotional units 200 or promotional units 300 situated about the store. Displays or inducements such as discounts, rebates, “points” toward some prize, etc. may be used to encourage the customer to interact with promotional units 200. Interaction with promotional units 300 occurs when the customer's individual card 100 is within sufficient physical proximity to a promotional unit 300 for the card and the promotional unit to communicate. Each promotional unit 200, 300, which interacts with individual card 100, transmits promotional unit data (e.g., a unique code) to promotional units 200, 300. In this way, individual card 100 is able to maintain, for example, a record of each promotional unit with which it has had interaction. Individual card 100 may maintain other information, as well, such as the times when each interaction occurred. Furthermore, promotional unit data may represent other information such as products, manufacturers, store location, etc. Individual card 100 may also maintain state variables that are modified by certain interactions (or certain numbers of interactions). Modification of certain variables may indicate that awards (rebates, discounts, prizes, etc.) are due the customer. When the customer leaves the store, administrative unit 400 reads the contents of the customer's individual card 100. Individual card 100 may also be initialized at that time. By thus reading the contents of the customer's individual card 100, it is possible to obtain, for example, a list of all the promotional units 200, 300 which interacted with individual card 100 or, what products, types of products, store location, etc. the customer considered.

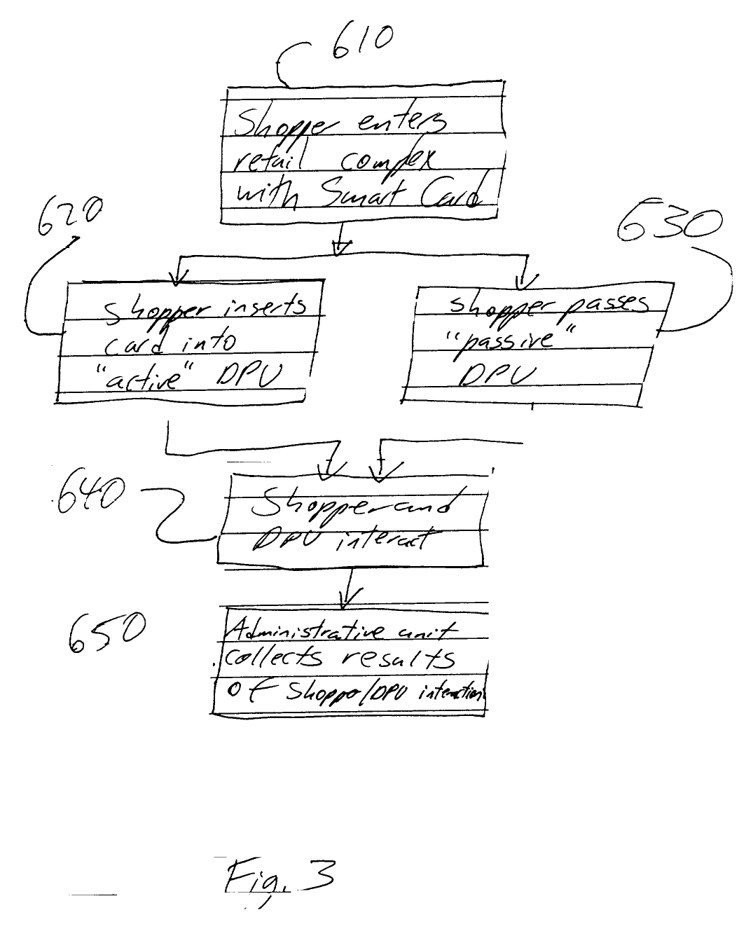

Operation of an exemplary embodiment of the present invention is illustrated with the flow chart diagram included in FIG. 3. As shown at step 610, an individual (e.g., shopper) enters a complex (i.e., a retail complex) with a card. At step 620, the shopper inserts the card into an “active” promotional unit. Alternatively, at step 630, the shopper passes a “passive” promotional unit. At step 640, the card and the promotional unit being used interact. As shown, step 620-640 may be repeated. Finally, at step 650, the administrative unit collects results of shopper/promotional unit interaction.

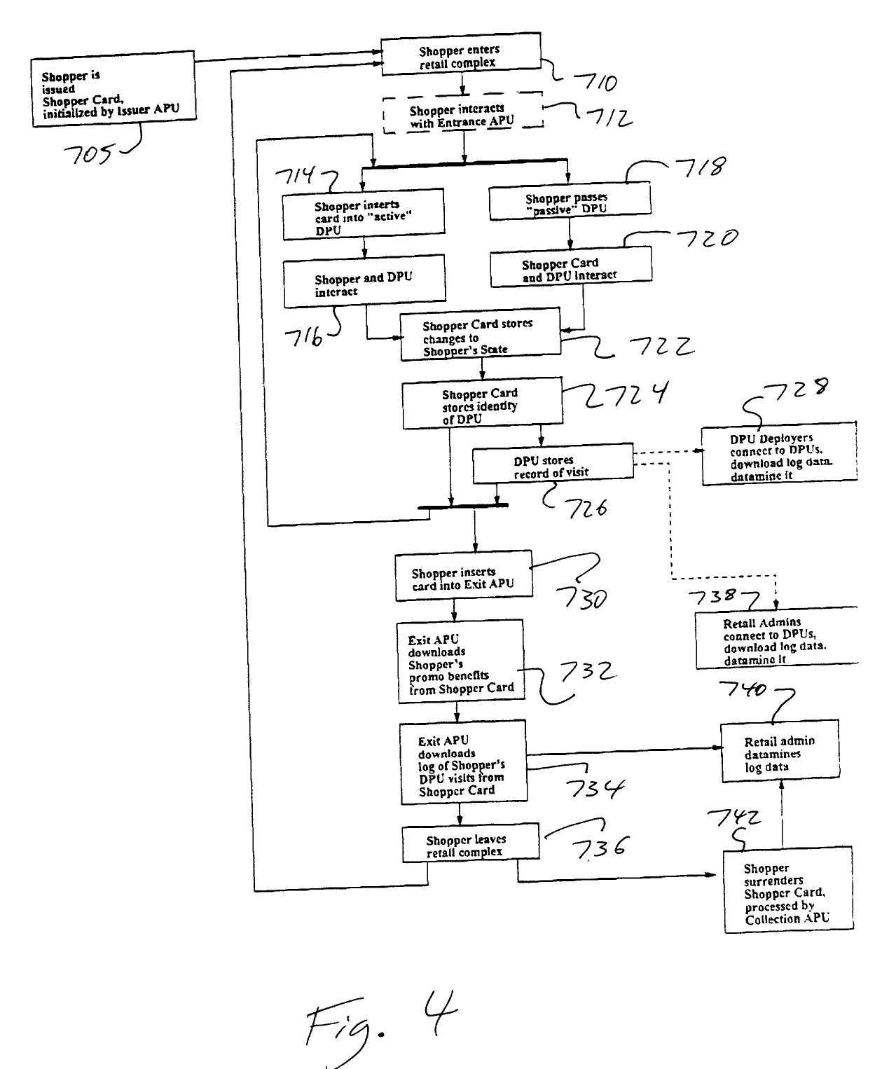

A further exemplary embodiment of the present invention is shown in the flow chart diagram which appears in FIG. 4. At step 705, a shopper is issued individual card 100. Individual card 100 is initialized by administrative unit 400 which issues shopping cards. At step 710, the shopper enters a retail complex. At step 712, the shopper may interact with administrative unit 400 (same or different from administrative unit 400 which issued individual card 100) located at the entrance. The shopper will then interact with zero or more promotional units 200, 300. At step 714, for example, the shopper inserts his/her card into “active” promotional unit 200. The shopper and promotional unit 200 then interact at step 716. Alternatively, at step 718, the shopper passes a “passive” promotional unit 300. At step 720, the shopper card and promotional unit 200, 300 then interact.

When card 100 and promotional unit 200, 300 interact, sufficient data passes from promotional units 200, 300 to card 100 so that the card has a record of interaction with a particular promotional unit (optionally at a certain time). Thus, each promotional unit 200, 300 may have unique promotional unit data (i.e., a unique identifier). This data is transmitted to card 100 when card 100 and promotional units 200, 300 interact.

The data stored on card 100 may be accessible to other promotional units 200, 300. Thus, a promotional unit 200, 300 can interact with card 100 differently depending upon the data stored on card 100. Different data may cause, for example, codes corresponding to different promotions to be stored on card 100 for later redemption. Alternatively, the shopper could be prompted to change his/her behavior (e.g., look at a competitor's product or pricing, go to a different part of the store, offer a promotion based on the time period which had elapsed since a previous identifier had been stored, etc.).

At step 722, state variables within individual card 100 may also be modified as the result of interactions within certain promotional units 200, 300. These variables, when modified, may indicate for example that the customer is entitled to discounts, rebates, prices, etc.

At step 724, as each promotional unit 200, 300 transmits unique promotional unit data, individual card 100 stores some or all of the promotional unit data that it receives. The respective times at which promotional unit data is stored in cards may also be stored.

Processing may then proceed, for example, in one of three ways.

In a first example, processing continues with either step 714 or step 718 as the shopper continues to move through the retail complex.

In another example, at step 726, administrative unit 400 stores a record of the shopper's visit. At step 728, promotional unit deployer 515 then connects to one or more administrative units 400, downloads data, and data mines this data. Alternatively, retail admin 520 may connect to promotional units 200, 300, downloads logged data, and data mines this data.

As a further example, at step 730, the shopper may insert his/her card into an exit administrative unit 400. At step 732, exit administrative unit 400 downloads promotional benefits into, for example, individual card 100 or a point-of-sale device. At step 734, administrative unit 400 downloads a log of the shopper's promotional unit visit from individual card 100. Retail admin 520 may then log this data at step 740. At step 736, the shopper leaves the retail complex. At step 742, the shopper surrenders the individual card 100 which is processed by a collection administrative unit. Processing may then, again, proceed to step 740 for data mining of logged data by retail admin 520. The shopper may then enter another retail complex at step 710, if desired.

Promotional unit interactions may change shopper-specific promotional benefits stored in the shopper card. The card and/or the promotional unit may also record a log of the time and nature of the visit.

The purpose for the shopper may be to obtain a “better deal.” This may be accomplished, for example, by accruing promotional benefits. The purpose for the deployers (e.g., the company that owns administrative units 200, 300, however, is to increase revenue and to gather data on shopper behavior. This may be accomplished, for example, for better marketing. To this end, both the deployer and the retail administrators (e.g., retail store management) may wish to collect the logged data. This may be collected from individual cards 100, or from promotional units 200, 300. This may be accomplished, for example, by a network connection to an exit administrative unit, by the various promotional units being networked together, or by occasional connections to the promotional units using an appropriate portable device.

A further exemplary embodiment of this invention may include the use of a grocery store “frequent shopper” card.

In the example above, the retail administrator is the store itself. The store may place “passive” promotional units 300 at various points in the store to monitor customer movement. “Active” promotional units 200 may be leased, for example, to food-item vendors.

“Active” promotional units 200, optionally, may display some type of discount. The interactions may be personalized to make interactions more attractive for the customer. The interactions can also depend on other variables, such as time of day or day of week.

Interaction could also be non-deterministic. Thus, discounts or other inducements may be provided randomly or a certain percentage of the time. Non-tangible inducements such as “points” could be accumulated and redeemed.

Optionally, the store could use interactions to attempt to direct the customer (with audio or visual messages, for example) to other points in the store.

An “active” promotional unit 200 could be combined with a “passive” promotional unit 300. Thus, an audible or visual signal may be provided to customer when a customer walks by to encourage the customer to insert his/her card.

Promotional units may be placed in a variety of stores.

Another exemplary embodiment of the present invention relates to the use of tickets issued in parking garages. For example, the retail administrator may issue individual card 100 when the shopper enters the parking garage and may collect individual card 100 upon exit. A customer can activate a promotional unit 200, 300 with his/her individual card 100, thus triggering an interaction which could include, for example, a validation, as well as other special offers.

Administrative units (or point-of-sale devices) 400 at individual stores may download demographic and benefits data. This example permits aggressive competition. For example, a small locally owned book store may advertise that they will give a discount to visitors to a national chain who then come to their store.

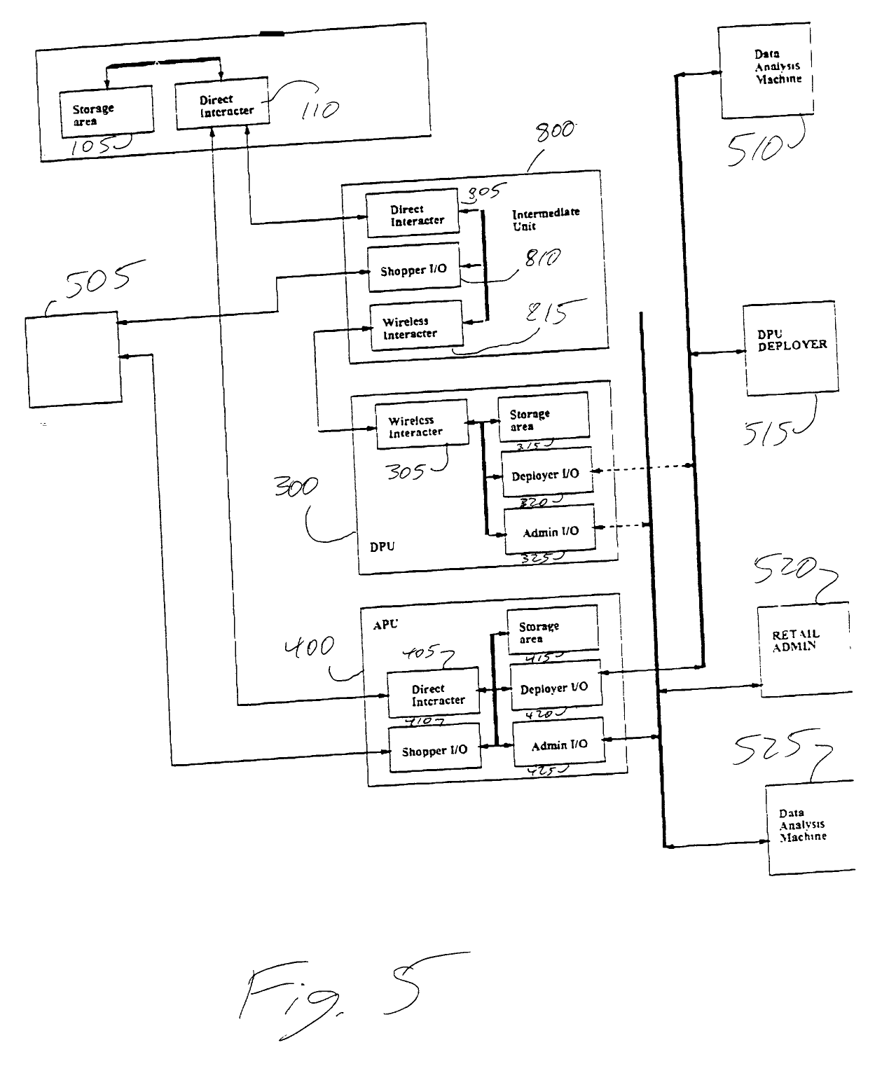

A further exemplary embodiment of the present invention is shown in FIG. 5. This exemplary embodiment may be useful in situations where excessive interactions between the smart card and the promotional units may be occurring. Thus, for example, to cause an active interaction, a shopper may desirably physically insert his/her individual card 100 into various promotional units 200 attached to various shelves. During rush hours, however, shoppers may not interact with promotional units 200 which are currently in use by another shopper.

One solution to this problem is to introduce intermediate unit 800. Intermediate unit 800 may be obtained from shoppers at the entrance. Intermediate unit 800 may be personalized by inserting individual card 100 therein, and leaving the intermediate unit 800 with the retail store upon exit. This intermediate unit 800 could absorb some of the more complex tasks of the shopper card (e.g., wireless interaction) and some of the “bottlenecks” of promotional units, such as customer I/O.

For example, intermediate unit 800 may be a smart card reader with RF communication, mounting on a shopping cart. The shopper inserts his/her individual card 100 in the reader and begins the process of shopping. When the shopper walks by a store shelf, the card reader communicates card holder information to promotional unit 300 which, in turn, may record this information and provide special discounts and promotions and targeted prices for the items on the shelf to the shopper by transmitting promotional unit data to intermediate unit 800. A single promotional unit 300 could serve multiple customers by using simple techniques to avoid interference such as multiple bands or multiplexing. Promotions, discounts and targeted prices offered by the promotional units appear on the display on the shopper's cart. These promotions may be displayed, for example, in a manner which results in the shopper having to interact with the card reader device in the event he/she is interested in viewing details of these promotions. In this manner, the device can record whether the shopper was interested in promotions on the isle or ignored them.

Whether or not intermediate unit 800 is used, the products associated with the promotional units 200, 300 that communicated with the shopper's individual card 100 may be compared with the products which the shopper's actually purchased. In this way, for example, it is possible to compare the products of which the individual was aware with the products which the customer actually purchased.

Although the invention is illustrated and described herein with reference to specific embodiments, the invention is not intended to be limited to the details shown. Rather, various modifications may be made in the details within the scope and range of equivalents of the claims and without departing from the invention.

What is Claimed:

1. A system for collecting information associated with movement between locations, comprising:
a plurality of individual cards, each of said individual cards including:
a respective storage area; and
a respective interactor for receiving promotional unit data and for transferring said received promotional unit data to said respective storage area as a respective one of said cards moves between locations;
a plurality of promotional units, each transmitting respective promotional unit data to any of said cards, said respective promotional unit data one of a) transmitted by said respective one of said promotional units, and b) received by any one of said cards, when said any one of said cards and said respective one of said promotional units are in proximity for communications between them to occur; and
an administrative unit for receiving all of said promotional unit data situated in said respective storage area of any one of said cards.

2. A system for collecting information associated with movement between locations according to claim 1, wherein said any one of said cards stores in said respective storage area a time when said respective storage area receives said respective promotional unit data.

3. A system for collecting information associated with movement between locations according to claim 1, wherein each storage area includes a state variable which is modified responsive to one of said promotional units communicating with said respective one of said cards.

4. A system for collecting information associated with movement between locations according to claim 1, wherein said one of said promotional units communicates with said respective one of said cards to modify said state variable responsive to human interaction with said one of said promotional units.

5. A system for collecting information associated with movement between locations according to claim 3, wherein said respective one of said promotional units communicates with any one of said cards responsive to said any one of said cards communicating with said respective one of said promotional units.

6. A system for collecting information associated with movement between locations according to claim 3, wherein said state variable is modified based on which of said promotional units said respective one of said cards communicates with.

7. A system for collecting information associated with movement between locations according to claim 1, further comprising a further administrative unit for dispensing said cards to a plurality of individuals, respectively, each card uniquely identifying a respective one of said individuals.

8. A system for collecting information associated with movement between locations according to claim 1, further comprising a further administrative unit for one of initializing and modifying said cards.

9. A system for collecting information associated with movement between locations according to claim 1, wherein each of said promotional units is associated with a plurality of products, respectively, further comprising means for comparing at least a portion of said promotional unit data stored in one of said cards with ones of said products acquired by an individual.

10. A system for collecting information associated with movement between locations according to claim 1, wherein said interactor is a direct interactor which makes physical contact with ones of said promotional units in order to communicate.

11. A system for collecting information associated with movement between locations according to claim 1, wherein said interactor is a wireless interactor which communicates with ones of said promotional units over a wireless medium.

12. A system for collecting information associated with movement between locations according to claim 1, wherein ones of said promotional units are standalone and disconnected one from another.

13. A system for collecting information associated with movement between locations according to claim 1, wherein one of said promotional units provides a response based on what promotional unit data is stored in said respective storage unit.

14. A system for collecting information associated with movement between locations according to claim 3, wherein one of said promotional units provides a response based on said state variable.

15. A system for collecting information associated with movement between locations according to claim 1, wherein communicating with ones of said promotional units provides a monetary realization to said individual.

16. A system for collecting information associated with movement between locations according to claim 1, further comprising an intermediate unit, wherein one of said cards and ones of said promotional units communicate through said intermediate unit.

17. A system for collecting information associated with movement between locations according to claim 1, further comprising a further administrative unit for statistically analyzing said promotional unit data stored in ones of said cards to identify correlations based on said data.

18. A method of collecting information associated with movement between locations having respective promotional units, said method comprising the steps of:
providing a plurality of individual cards each having a respective storage area to a respective plurality of individuals;
having any one of said promotional units provide respective promotional unit data to any one of said cards which interacts therewith and storing said respective promotional unit data in said respective storage area of said respective one of said cards; and
receiving said respective promotional unit data from respective ones of said cards.

19. A method of collecting information associated with movement between locations having respective promotional units according to claim 18, further comprising the step of storing respective times of when respective ones of said cards receives promotional unit data.

20. A method of collecting information associated with movement between locations having respective promotional units according to claim 18, wherein each respective storage area includes a respective state variable, further comprising the step of modifying said state variable responsive to interaction with one of said promotional units.

21. A method of collecting information associated with movement between locations having respective promotional units according to claim 18, wherein each respective storage area includes a respective state variable, further comprising the step of modifying said state variable responsive to human interaction with one of said promotional units.

22. A method of collecting information associated with movement between locations having respective promotional units according to claim 18, further comprising the step of one of said promotional units communicating with one of said cards responsive to one of said cards communicating with one of said promotional units.

23. A method of collecting information associated with movement between locations having respective promotional units according to claim 18, wherein one of said cards includes a state variable, further comprising the step of modifying said state variable based on which of said promotional units said respective one of said cards communicates with.

24. A method of collecting information associated with movement between locations having respective promotional units according to claim 18, further comprising the step of comparing at least a portion of said promotional unit data stored in ones of said cards with products acquired by an individual.

25. A method of collecting information associated with movement between locations having respective promotional units according to claim 18, further comprising the step of providing a monetary realization after one of said cards and one of said promotional units have communicated.

26. A method of collecting information associated with movement between locations having respective promotional units according to claim 18, wherein said promotional unit data is transmitted from ones of said promotional units to one of said cards through an intermediate unit.

27. A method of collecting information associated with movement between locations having respective promotional units according to claim 18, further comprising the step of statistically analyzing said promotional unit data stored in said cards to identify correlations based on said data.

28. A system for collecting information associated with movement of shoppers between locations in a retail complex, comprising:
a plurality of individual cards, each of said individual cards corresponding to a respective one of said shoppers, each of said cards including:
a respective storage area; and
a respective interactor for receiving promotional unit data and for transferring said received promotional unit data to said respective storage area as a respective one of said shoppers moves their respective card between locations;
a plurality of promotional units, each transmitting respective promotional unit data to any of said cards, said respective promotional unit data one of a) transmitted by said respective one of said promotional units, and b) received by any one of said cards, when said any one of said cards and said respective one of said promotional units are brought in proximity by one of said shoppers for communications between them to occur; and
an administrative unit for receiving all of said promotional unit data situated in said respective storage area of any one of said cards.

29. A system for collecting information associated with movement of shoppers between locations in a retail complex according to claim 28, further comprising a further unit for analyzing said data received by said administrative unit to obtain information associated with movement of said shoppers.

30. A system for collecting information associated with movement of said shoppers between locations in a retail complex according to claim 29, wherein said information obtained corresponds to products acquired and not acquired by said shoppers.

31. A method of collecting information associated with movement of shoppers between locations in a retail complex, said locations having respective promotional units, said method comprising the steps of:
providing a plurality of individual cards each having a respective storage area to said shoppers;
having any one of said promotional units provide respective promotional unit data to any one of said cards which said shoppers cause to interact therewith as said shoppers move through said retail complex and storing said respective promotional unit data in said respective storage area of said respective one of said cards; and
receiving said respective promotional unit data from respective ones of said cards.

32. A method of collecting information associated with movement of shoppers between locations in a retail complex according to claim 31, wherein said data received by said administrative unit is analyzed to obtain information associated with movement of said shoppers.

33. A method of collecting information associated with movement of shoppers between locations in a retail complex according to claim 32, wherein said information obtained corresponds to products acquired and not acquired by said shoppers.

34. An article of manufacture comprising a computer usable medium having computer readable program code means embodied therein for collecting information associated with movement between locations having respective promotional units, the computer readable program code means in said article of manufacture comprising computer readable program code means for causing a computer to effect:
providing a plurality of individual cards each having a respective storage area to a respective plurality of individuals;
having any one of said promotional units provide respective promotional unit data to any one of said cards which interacts therewith and storing said respective promotional unit data in said respective storage area of said respective one of said cards; and
receiving said respective promotional unit data from respective ones of said cards.

35. An article of manufacture as recited in claim 34, the computer readable program code means in said article of manufacture further comprising computer readable program code means for causing a computer to effect:
storing respective times of when respective ones of said cards receives promotional unit data.

36. An article of manufacture as recited in claim 35, wherein each respective storage area includes a respective state variable, and the computer readable program code means in said article of manufacture further comprising computer readable program code means for causing a computer to effect:
modifying said state variable responsive to interaction with one of said promotional units.

37. An article of manufacture as recited in claim 34, wherein each respective storage area includes a respective state variable, fisher comprising the step of modifying said state variable responsive to human interaction with one of said promotional units.

38. An article of manufacture as recited in claim 34, the computer readable program code means in said article of manufacture further comprising computer readable program code means for causing a computer to effect the step of one of said promotional units communicating with one of said cards responsive to one of said cards communicating with one of said promotional units.

39. An article of manufacture as recited in claim 34, wherein one of said cards includes a state variable and the computer readable program code means in said article of manufacture further comprising computer readable program code means for causing a computer to effect:
modifying said state variable based on which of said promotional units said respective one of said cards communicates with;
comparing at least a portion of said promotional unit data stored in ones of said cards with products acquired by an individual; and
providing a monetary realization after one of said cards and one of said promotional units have communicated.

40. A program storage device readable by machine, tangibly embodying a program of instructions executable by the machine to perform method steps for collecting information associated with movement of shoppers between locations in a retail complex, said locations having respective promotional units, said method comprising the steps of:
providing a plurality of individual cards each having a respective storage area to said shoppers;
having any one of said promotional units provide respective promotional unit data to any one of said cards which said shoppers cause to interact therewith as said shoppers move through said retail complex and storing said respective promotional unit data in said respective storage area of said respective one of said cards; and
receiving said respective promotional unit data from respective ones of said cards.

41. A program storing device as recited in claim 40, wherein said data received by said administrative unit is analyzed to obtain information associated with movement of said shoppers.

42. A program storing device as recited in claim 41, wherein said information obtained corresponds to products acquired and not acquired by said shoppers.

43. A computer program product comprising a computer usable medium having computer readable program code means embodied therein for causing a collection of information associated with movement of shoppers between locations in a retail complex, said locations having respective promotional units, computer readable program code means in said computer program product comprising computer readable program code means for causing a computer to effect:
providing a plurality of individual cards each having a respective storage area to said shoppers;
having any one of said promotional units provide respective promotional unit data to any one of said cards which said shoppers cause to interact therewith as said shoppers move through said retail complex and storing said respective promotional unit data in said respective storage area of said respective one of said cards; and
receiving said respective promotional unit data from respective ones of said cards.

44. A computer program product as recited in claim 43, wherein said data received by said administrative unit is analyzed to obtain information associated with movement of said shoppers.

45. A computer program product as recited in claim 44, wherein said information obtained corresponds to products acquired and not acquired by said shoppers.
